(19) United States
(12) Patent Application Publication
(10) Pub. No.: US 2024/0385207 A1
(43) Pub. Date: Nov. 21, 2024

(54) VALVE CAGE, PISTON, GLOBE VALVE, ANALYTICAL ASSEMBLY, USE OF AN ANALYTICAL ASSEMBLY AND METHOD FOR MONITORING A PROCESS FLUID FLOW

(71) Applicant: Samson Aktiengesellschaft, Frankfurt am Main (DE)

(72) Inventors: Andreas Widl, Muenchen (DE); Thomas Steckenreiter, Roedermark (DE); Rainer Oberheim, Bensheim (DE)

(73) Assignee: Samson Aktiengesellschaft, Frankfurt am Main (DE)

(21) Appl. No.: 18/261,556

(22) PCT Filed: Dec. 9, 2021
(86) PCT No.: PCT/EP2021/085089

§ 371 Date: Jul. 14, 2023

(30) Foreign Application Priority Data
Jan. 14, 2021 (DE) 102021100689.9

(51) Int. Cl. G01N 35/10; F16K 1/32

(52) U.S. Cl. CPC G01N 35/1097; F16K 1/32

(57) ABSTRACT

A valve cage for guiding an actuator, such as a stroke piston, may be used in a control valve for adjusting a process fluid flow (e.g., a water flow) in a process plant (e.g., a food processing plant, a brewery, etc.) The control valve may include a sensor for detecting a chemical and/or biological property of the process fluid, and at least one analyzer for the process fluid that is arranged on the valve cage such that the analyzer can interact with process fluid.

### CROSS REFERENCE TO RELATED APPLICATIONS

This patent application is a U.S. National Stage application of International Application No. PCT/EP2021/085089, filed Dec. 9, 2021, which claims priority to German Patent Application No. 102021100689.9, filed Jan. 14, 2021, each of which is incorporated herein by reference in its entirety.

### BACKGROUND

### Field

The disclosure relates to a control valve for adjusting a process fluid flow, in particular a water flow, in a process plant, such as a food processing plant, for example a brewery.

### Related Art

The disclosure further relates to a stroke piston for a control valve or a valve cage for guiding an actuator, such as a stroke piston, in a control valve. Furthermore, the disclosure relates to an analysis arrangement for determining a chemical and/or biological property of a process fluid, in particular a biological contamination of the process fluid, such as bacteria or viruses, in a process plant, such as a food processing plant, for example a brewery, and the use of such an analysis arrangement. Furthermore, the disclosure relates to a method for monitoring a process fluid flow, in particular a water flow, in a process plant, such as a food processing plant, for example a brewery, with respect to a chemical and/or biological property, in particular a biological contamination, such as bacteria or viruses.

In process plants where process fluids are processed that are intended for consumption, for medical administration, or otherwise for contact with the human body, it may be desirable or necessary to ensure that the process fluids are not contaminated. In particular, chemical and/or biological contaminations are relevant. Biological contaminations may include, for example, contamination of the process fluid with germs, such as bacteria, viruses, spores, or the like. Process fluids for consumption include, for example, beverages, such as water, milk, alcoholic beverages, non-alcoholic beverages, or the like, as well as other liquid foods or food precursors, such as milk products, soups, sauces, broths, mash, food coloring, or the like. Process fluids for medical administration include, for example, solutions for various modes of administration, such as oral, intravenous, dermal, subcutaneous, inhalation, nasal, or the like. Other process fluids intended for contact with the human body, may include, for example, cosmetic products or precursors, for example, ointments, lotions, or medical products, such as ultrasound gel or the like.

Specific examination of certain chemical and/or biological properties of fluids, such as the detection of viruses, can only take place in certain rooms suitable for this purpose. Simply placing a sensor in the housing of a control valve, as suggested by EP 2 959 197 A1, is not sufficient for this purpose.

In many processes, it is common for spot samples to be branched off from the ongoing, continuous processing of a process fluid by means of an outlet valve or to be taken in some other way in order to examine these samples in an analysis chamber of a laboratory outside the process plant for their chemical and/or biological properties, in particular contamination. With such spot sample test, an estimate can be made regarding the biological and/or chemical properties of a process fluid production batch from which the spot sample was taken. With the help of such spot samples, the marketing of contaminated process fluid batches can be prevented or a recall can be justified. A prompt correction of the running process is impossible due to the time offset between spot sample extraction and spot sample laboratory analysis.

From DE 10 2005 051 279 B4, a measuring head is known that can be inserted into a housing or container to receive a sample of a medium whose property is to be measured with the measuring head. For example, the manufacture of sterile solutions in the sense of pharmaceuticals and medical devices for dialysis applications requires the use of pH measuring heads to monitor the manufacturing process. The measuring head forms an input port to complex fluid system with multiple valve components to control the inflow and outflow of various fluids, including the actual sample.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1A a first embodiment of an analysis arrangement with a valve piston forming an analysis chamber with a valve cage, in an open and receiving position;

FIG. 1B the control valve of the first embodiment of the analysis arrangement in a closed and analysis position;

FIG. 1C the control valve of the first embodiment of the analysis arrangement in an intermediate position;

FIG. 2A a second embodiment of an analysis arrangement with a valve piston, which forms an analysis chamber with a valve cage, in an open and analysis position;

FIG. 2B the control valve of the second embodiment of the analysis arrangement in a closed and receiving position;

FIG. 3A a third embodiment of an analysis arrangement with a valve piston, which forms an analysis chamber with a valve cage, in a closed and receiving position;

FIG. 3B the control valve of the third embodiment of the analysis arrangement in an intermediate and analysis position;

FIG. 3C the control valve of the third embodiment of the analysis arrangement in another intermediate and analysis position, with the valve piston acting as a displacement piston;

FIG. 3D a sectional view through the analysis chamber of the control valve of the third embodiment of the analysis arrangement;

FIG. 4 a fourth embodiment of an analysis arrangement with a valve piston forming an analysis chamber with an inner housing wall;

FIG. 5 a fifth embodiment of an analysis arrangement with a valve piston which forms an analysis chamber with an inner housing wall;

FIG. 6A a sixth embodiment of an analysis arrangement with a valve piston that has an analysis chamber with through openings;

FIG. 6B the control valve of the sixth embodiment of the analysis arrangement in an open position.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure. The connections shown in the figures between functional units or other elements can also be implemented as indirect connections, wherein a connection can be wireless or wired. Functional units can be implemented as hardware, software or a combination of hardware and software.

It is an object of the disclosure to overcome disadvantages of the prior art, and in particular to create a possibility to make a fast, precise and reliable statement regarding the chemical and/or biological properties, in particular a contamination, of a process fluid in a process engineering plant. This object is solved by the objects of independent claims 1, 3, 6, 13, 14, 23, 35 and 36.

Accordingly, a valve cage for guiding an actuator, such as a stroke piston, in a control valve for adjusting a process fluid flow, in particular a water flow, in a process plant, such as a food processing plant, for example a brewery, is provided. The control valve includes a sensor for detecting a chemical and/or biological property of the process fluid. According to a first aspect of the disclosure, there is provided at least one analysis means for the process fluid arranged on the valve cage such that the analysis means can interact with process fluid. The provision of an analysis means on the valve cage may, in particular in the case of a control valve with a detachably inserted valve cage, be intended to allow easy retrofitting of the control valve to improve its analysis capabilities. In the case of an analysis means provided on the valve cage, for example, biological and/or chemical properties of the process fluid inside the control valve housing can be determined. In an exemplary embodiment, the at least one analysis means of the valve cage comprises at least one sensor for detecting a chemical and/or biological property of the process fluid. In particular, the analysis means of the valve cage comprises the sensor of the control valve. With a sensor arranged in the control valve, on the valve cage for determining a chemical and/or biological property of the process fluid, a control feedback is possible, so that the process fluid flow, which can be adjusted with the control valve, can be controlled considering the chemical and/or biological property of the process fluid determined by the at least one sensor. The at least one analysis means of the valve cage may comprise a filter through which process fluid can flow into the inner space of the valve cage, preferably filtered, and/or through which process fluid can flow out of the inner space of the valve cage, preferably filtered, in particular out of and/or into an interior of the control valve housing connected to the inlet and/or outlet of the control valve housing for the process fluid flow.

According to one embodiment, the valve cage comprises a sleeve body defining an inner space for receiving the actuator. In particular, the sleeve body is form-fitted to the actuator. Alternatively, or additionally, the analysis means is configured and adapted to interact with the process fluid in the inner space of the sleeve body. In an exemplary embodiment, the sleeve body and the actuator, in particular the stroke piston, are matched to one another in such a way that a preferably closed, in particular process fluid-tight, analysis chamber is formed between the actuator and the stroke piston at least in an operating position, in particular an analysis position, of the control valve, wherein the at least one analysis means is arranged on or in the analysis chamber and/or communicates fluidically with the analysis chamber.

Alternatively, or additionally, a valve cage is provided for guiding an actuator, such as a stroke piston, in a control valve for adjusting a process fluid flow, in particular a water flow, in a process plant, such as a food processing plant, for example a brewery. The control valve has a control valve housing carrying process fluid and has a sensor for detecting a chemical and/or biological property of the process fluid. According to a second aspect of the disclosure, combinable with the first aspect, the valve cage comprises at least one analysis channel, in particular comprising a check valve, for leading process fluid from an inner space of the valve cage to at least one analysis means, in particular outside the control valve housing. In an exemplary embodiment, the at least one analysis means comprises, in particular outside the control valve housing, at least one sensor for detecting a chemical and/or biological property of the process fluid. In particular, the analysis means arranged outside the control valve housing forms the sensor of the control valve. The provision of an analysis channel on the valve cage can, in particular in the case of a control valve with a detachably inserted valve cage, be intended for simple retrofitting of the control valve to improve its analysis capacities. With the aid of such a valve cage, numerous known, established analysis devices can be supplied with process fluid directly from the inside of a control valve in a partially or fully automated manner with the aid of the analysis channel in order to precisely analyze this process fluid in the process plant. In an exemplary embodiment, the analysis channel guides to the at least one sensor or the multiple sensors of the control valve outside the control valve housing. With a sensor arranged at or near the control valve, outside the control valve housing, for determining a chemical and/or biological property of the process fluid, a control feedback is possible, so that the process fluid flow, which can be adjusted with the control valve, can be controlled considering the chemical and/or biological property of the process fluid determined by the at least one sensor.

According to a further development, the control valve housing comprises a pump for delivering the process fluid from the inner space of the control valve housing, in particular from the inner space of the control valve housing, out to the at least one analysis means outside the control valve housing. The pump can be arranged, for example, in the valve cage, in particular the sleeve body, or outside the valve cage, on the control valve, in particular on the control valve housing.

According to an embodiment of a valve cage based on the first and/or second aspect of the disclosure, the valve cage comprises at least one radial retaining web for attachment to the control valve housing. The at least one analysis means on the valve cage according to the first aspect of the disclosure may be received in the retaining web. Alternatively, or additionally, the at least one analysis channel according to the second aspect of the disclosure may be received in the retaining web. The use of at least one retaining web is useful both for structurally fixing the valve cage to the control valve housing and for accommodating at least one analysis channel and/or at least one analysis means in view of easy use of the valve cage, in particular for connecting an analysis means, its installation, removal, calibration and/or maintenance. In an exemplary embodiment, the valve cage comprises a plurality of retaining webs, for example two, three, five or more. In an exemplary embodiment, a plurality of retaining webs are distributed uniformly, in particular equidistantly, around the circumference of the valve cage. In an exemplary embodiment, a corresponding or greater number of analysis means are arranged in at least one or more of the plurality of retaining webs of a valve cage. Alternatively, or additionally, a corresponding or larger number of channels, in particular comprising at least one analysis channel, may be arranged in at least one or more of the plurality of retaining webs of a valve cage. In the case of a valve cage having a plurality of channels, at least one channel may be provided for introducing a flushing liquid, cleaning liquid and/or calibration liquid into the inner space of the valve cage. In an exemplary embodiment, the valve cage comprises a channel, in particular an analysis channel, which fluidically connects the pump to the inner space of the valve cage according to the embodiment above. In particular, the valve cage may comprise at least one analysis means in at least one retaining web and at least one analysis channel or other channel in at least one, preferably other, retaining web. In an exemplary embodiment, the valve cage comprises both at least one analysis means and at least one channel, in particular an analysis channel, in an individual retaining web. In an exemplary embodiment, the valve cage and the valve housing are adapted to each other in such a way that a flange section of the valve cage can be arranged, preferably fastened, on the valve housing in axial direction preferably corresponding to the adjustment axis. The flange section can be connected, in particular fully or partially circumferentially, to the retaining web. Flange section and retaining web can be realized in particular in functional union, that is, the retaining web can partially or fully surround the sleeve body of the valve cage to create a preferably flange-like connection to the control valve housing. The valve housing may comprise a collar section to the upper end of which the retaining web and/or flange section of the valve cage may be attached. Above the retaining web and/or flange section of the valve cage, a housing cover and/or lantern or the like of the control valve may be arrangeable, in particular to support the actuator.

According to a third aspect of the disclosure, which is combinable with the first and/or the second aspect of the disclosure, a stroke piston is provided for a control valve for adjusting a process fluid flow, in particular a water flow, in a process plant such as a food processing plant, for example a brewery. The control valve has at least one sensor for detecting a chemical and/or biological property of the process fluid. The stroke piston comprises a counter sealing surface adapted to a sealing surface, such as a valve seat, of the control valve, in particular of a valve cage. According to the third aspect of the disclosure, the stroke piston is provided at least partially delimiting an analysis chamber for receiving the process fluid. In an exemplary embodiment, the at least one sensor for detecting a chemical and/or biological property of the process fluid is in fluidic communication with the at least one analysis chamber. In particular, the at least one sensor for detecting at least one chemical and/or biological property of the process fluid may be arranged at or in the analysis chamber. In an exemplary embodiment, the control valve partially delimits exactly one analysis chamber. In particular, the stroke piston is adapted to the control valve, in particular the valve housing and/or the valve cage, in such a way that in at least one predetermined first relative position of the stroke piston with respect to the control valve housing, the analysis chamber is open with respect to a valve housing interior, wherein the valve housing interior fluidically communicates with the inlet and/or the outlet of the valve housing in the relative position of the stroke piston. In addition, the stroke piston can be adapted to the control valve, in particular the valve housing and/or the valve cage, in such a way that in at least one predetermined second relative position of the stroke piston with respect to the control valve housing, the analysis chamber is separated from the rest of the valve housing interior, preferably in a process fluid-tight manner, wherein in particular this second relative position of the stroke piston can correspond to an analysis position of the control valve.

According to one embodiment, at least one analysis means for the process fluid is arranged on the stroke piston such that it can interact with process fluid, in particular with process fluid received within the analysis chamber. For example, with an analysis means provided on the stroke piston, biological and/or chemical properties of the process fluid inside the control valve housing can be determined. In an exemplary embodiment, the at least one analysis means of the stroke piston comprises at least one sensor for detecting a chemical and/or biological property of the process fluid. In particular, the analysis means of the stroke piston comprises the sensor of the control valve. With a sensor arranged in the control valve, on the stroke piston for determining a chemical and/or biological property of the process fluid, a control feedback is possible, so that the process fluid flow, which can be adjusted with the control valve, can be controlled considering the chemical and/or biological property of the process fluid determined by the at least one sensor. Alternatively, or additionally, at least one analysis means can be adapted to amplify at least one, in particular predetermined, biological and/or chemical property of the process fluid, for example to increase a concentration of a predetermined component and/or, for example, to separate, in particular to filter out, process fluid constituents with predetermined properties, such as a particle size, an electric charge or the like. In an exemplary embodiment, the at least one analysis means of the stroke piston comprises a filter. The at least one analysis means of the stroke piston may comprise a filter through which process fluid can flow into the analysis chamber, preferably filtered, and/or through which process fluid can flow out of the analysis chamber, preferably filtered, in particular out of and/or into an interior of the control valve housing connected to the inlet and/or outlet of the control valve housing for the process fluid flow.

According to another exemplary embodiment, which can be combined with the previous one, the stroke piston has an in particular cylindrical body, preferably rotationally symmetrical and/or mirror symmetrical with respect to the actuation axis, which delimits the in particular exclusively radially open analysis chamber in the axial stroke direction. In at least one operating position, for example an analysis position, the process fluid inside the analysis chamber is separated from the process fluid inside the control valve. In particular, the axial stroke direction corresponds to the direction of the actuator axis. In particular, the body of the stroke piston forms a preferably process fluid-tight closure of the analysis chamber in the axial direction. The analysis chamber can be closed in one or both axial directions by the body of the stroke piston, preferably in a process fluid-tight manner. In an exemplary embodiment, the body of the stroke piston surrounds the analysis chamber in a process fluid-tight manner on both sides in the axial stroke direction. It is conceivable that the analysis chamber is delimited on the one hand in a first axial direction by an in particular circular section of the valve housing, in particular of the valve cage, and on the other hand in a second axial direction, opposite to the first axial direction, by an in particular circular section of the stroke piston. The analysis chamber may have an annular shape or an annular section shape. In the radial direction, the analysis chamber is at least partially delimited by the control valve housing, in particular the valve cage. In an exemplary embodiment, in the radial direction, the analysis chamber is fully delimited externally by the control valve housing, in particular the valve cage. Alternatively, the analysis chamber can be delimited in the radial direction around its outer circumference at least partially by the stroke piston. By using the stroke piston to provide the analysis chamber, a determination of at least one biological and/or chemical property of the process fluid can be performed fast and accurately directly in the control valve. By segregating a process fluid sample (a test volume) within the analysis chamber from the rest of the process fluid inside the control valve, a precise determination of at least one biological and/or chemical property of the process fluid can be ensured. In particular, at least one biological and/or chemical property of the process fluid can be amplified in the analysis chamber without affecting the rest of the process fluid inside the control valve.

According to a development, it is provided that the analysis chamber is closed by the body in a process fluid-tight manner at a first side in the axial stroke direction and is open at a second side in the axial stroke direction. In particular, the body comprises a wall with at least one passage opening at the second side. In an exemplary embodiment, the body may comprise a plurality of passage openings, in particular narrow passage openings, which may be designed and adapted for pressure reduction. In particular, the stroke piston may be designed and adapted to have, in a closed position, at least one passage opening for process fluid to enter the analysis chamber, preferably from an inlet side interior of the control valve housing or an outlet side interior of the control valve housing. In an exemplary embodiment, the stroke piston is designed to be fluidically connected in a closed position with at least one passage opening to the inlet-side or outlet-side interior of the control valve housing and to be separated from the other, outlet-side or inlet-side, interior of the control valve housing, in particular in a process fluid-tight manner. Such an embodiment of the stroke piston can be advantageous, in particular, for such control valves where it is desired to determine a biological and/or chemical property of the process fluid in a closed position of the control valve either in the inlet-side interior or in the outlet-side interior.

According to an embodiment combinable with the previous ones, the stroke piston comprises at least one analysis channel for leading process fluid from the analysis chamber to at least one analysis means, in particular outside the control valve housing, in particular remote from the control valve. In an exemplary embodiment, the analysis channel is designed with at least one check valve. The use of at least one check valve in the analysis channel may be useful to ensure that, for example as a sample, process fluid conveyed to an outside of the control valve housing, in particular remote from the control valve, does not form a contamination risk with respect to the process fluid inside the control valve. The provision of an analysis channel on the stroke piston can aim at an easy retrofitting of the control valve to improve its analysis capacities. With the aid of such a stroke piston, numerous known, established analysis devices can be supplied with process fluid directly from the inside of a control valve in a partially or fully automated manner with the aid of the analysis channel in order to precisely analyze this process fluid in the process plant. In an exemplary embodiment, the analysis channel guides to the at least one sensor or the multiple sensors of the control valve outside the control valve housing. With a sensor arranged at or near the control valve, outside the control valve housing, for determining a chemical and/or biological property of the process fluid, a control feedback is possible so that the process fluid flow adjustable with the control valve can be controlled considering the chemical and/or biological property of the process fluid determined by the at least one sensor.

According to one embodiment, a stroke piston is provided comprising a pump for conveying the process fluid out of the analysis chamber, in particular the control valve housing, to the analysis means.

According to a fourth aspect, which is combinable with the previous aspects, the disclosure relates to a control valve for a process fluid flow, in particular a water flow, of up to at least 1 L/h in a process plant, such as a food processing plant, for example a brewery, comprising a control valve housing and an actuator, such as a stroke piston, displaceable relative to the control valve housing. The control valve may comprise, for example, a stroke piston described above. According to the disclosure, the actuator and the control valve housing are adapted to each other such that in at least one operating position the actuator assumes an analysis position in which the actuator together with the control valve delimits an analysis chamber for receiving process fluid, at which at least one analysis means is arranged for interacting with the process fluid. The analysis means may preferably be disposed within the analysis chamber or in fluid communication with the analysis chamber. The at least one analysis means may be attached to the actuator. Alternatively, or additionally, at least one analysis means may be attached to the control valve housing. In an exemplary embodiment, the control valve is adapted and arranged to assume at least two different operating positions, namely a closed position or shut position and an open position. In particular, the control valve may be designed and adapted to assume a plurality of different operating positions including a closed position and an open position as well as at least one, in particular a plurality of, intermediate positions. The intermediate positions and the open position define flow through positions. The operating positions of the control valve may correspond to different relative positions of the actuator relative to the control valve housing. An analysis means provided on the control valve can be used to determine, for example, biological and/or chemical properties of the process fluid inside the control valve housing. In an exemplary embodiment, the at least one analysis means of the control valve comprises at least one sensor for detecting a chemical and/or biological property of the process fluid. With a sensor arranged on or in the control valve for determining a chemical and/or biological property of the process fluid, a control feedback is possible, so that the process fluid flow adjustable with the control valve can be controlled considering the chemical and/or biological property of the process fluid determined by the at least one sensor.

According to a fifth aspect of the disclosure, which is combinable with the previous aspects, a control valve is provided for a process fluid flow, in particular a water flow, of up to at least 1 L/h in a process plant, such as a food processing plant, for example a brewery. The control valve comprises a control valve housing and an actuator displaceable relative to the control valve housing, such as a stroke piston, in particular a stroke piston described above. In the fourth aspect of the disclosure, it is provided that the actuator and the control valve housing are adapted to each other such that the actuator in at least one operating position assumes an analysis position in which the actuator together with the control valve delimits an analysis chamber for receiving process fluid, wherein the control valve comprises at least one analysis channel, in particular comprising a check valve, for leading process fluid from the analysis chamber to at least one analysis means, in particular outside the control valve housing. The provision of an analysis channel on the control valve can lead to an improvement of its analysis capacities. With the aid of such a control valve, numerous known, established analysis devices can be supplied with process fluid directly from the inside of a control valve in a partially or fully automated manner with the aid of the analysis channel in order to precisely analyze this process fluid in the process plant. In an exemplary embodiment, the analysis channel guides to the at least one sensor or the several sensors of the control valve, in particular outside the control valve housing. With a sensor arranged on or near the control valve, outside the control valve housing, for determining a chemical and/or biological property of the process fluid, a control feedback is possible, so that the process fluid flow that can be adjusted with the control valve can be controlled considering the chemical and/or biological property of the process fluid determined by the at least one sensor.

According to a further embodiment, the control valve comprises a pump for delivering process fluid out of the analysis chamber, in particular out of the control valve housing, to the analysis means. The pump can be arranged, for example, in the control valve, in particular the control valve housing, or outside the control valve housing, on the outside of the control valve, in particular the control valve housing.

In one embodiment, it is provided that the actuator in the control valve can assume as operating positions a closed position and at least one flow position, wherein the closed position or the flow position, corresponds to the analysis position. The closed position may also be referred to as the closed position. The at least one flow position comprises the open position and may comprise further intermediate or relative positions. According to a exemplary embodiment, the at least one flow position corresponds to the analysis position, wherein the control valve in the analysis position preferably seals off the analysis chamber from the rest of the interior of the valve housing in a process-fluid-tight manner, while the process fluid flow can flow from the inlet to the outlet, in particular in a variably adjustable and/or controllable manner. Depending on the design of the process plant, with such a control valve the operational use of the control valve as such as well as its analysis capacities can be used in parallel without restrictions or with only minor adjustments. According to another exemplary embodiment, the closed position corresponds to the analysis position, wherein in the analysis position the analysis chamber may be scaled off from the rest of the interior of the valve housing in a process fluid-tight manner, while, by the closed position, the process fluid at the inlet of the control valve may be separated from the process fluid at the outlet of the control valve in a process-fluid-tight manner and/or the process fluid flow is set to or near zero. Such an embodiment is particularly suitable for processing sensitive process fluids where at least one biological and/or chemical property of the process fluid must necessarily be within predetermined tolerance limits. Should it become apparent that the tolerance limits have been exceeded during analysis in or with the analysis chamber in the analysis and simultaneous closed position, the control valve can simply remain closed and appropriate countermeasures against the exceedance can be initiated without any further flow of a problematic process fluid flow through the process plant. In this way, not only the amount of process fluid waste can be minimized, but also the zone to be decontaminated in the process plant.

According to one embodiment of the control valve, the actuator and the control valve are matched to each other in such a way that, in at least one operating position, the actuator assumes a receiving position in which the actuator, together with the control valve, forms a fluidic connection between an area of the control valve through which fluid flows and a receiving space in the actuator and/or the control valve housing. The receiving space may correspond to the analysis chamber. The receiving position is different from the analysis position. In particular, the receiving position may correspond to the closed position and/or at least one flow position of the control valve. It should be understood that a control valve may assume the receiving position in a first flow position and the analysis position in a second flow position different from the first flow position, so that when the control valve is operationally open the control valve may switch between the receiving position and the analysis position, with no or little deviation of the setting of the process fluid flow from at least one predetermined desired flow characteristic, so that investigations of at least one biological and/or chemical property of the process fluid may be performed during ongoing operation of the process plant. Alternatively, the receiving position can correspond to the closed position and the analysis position can correspond to the at least one flow position, which can be advantageous for processes in which the closed position is assumed periodically, in particular regularly, or for process fluids whose at least one biological and/or chemical property is particularly sensitive in the closed position, i.e. when the process fluid is stationary.

In one embodiment, the at least one analysis means, in particular a plurality of analysis means, are arranged on a wall delimiting the analysis chamber. The wall section with analysis means arranged thereon may be part of the control valve housing, in particular a valve cage, or part of the actuator, in particular the stroke piston. Several analysis means may be arranged in the control valve on the same or on different wall sections.

In one embodiment of a control valve, the valve housing comprises a valve cage for guiding the actuator, wherein the analysis chamber is delimited by the actuator, in particular the stroke piston, and the valve cage together. In particular, the valve cage may be embodied according to the first and/or second aspect of the disclosure. The analysis position and/or the receiving position may be defined by different relative positions of the actuator with respect to the valve cage. In at least one position of the actuator, in particular of the stroke piston, relative to the valve cage, an analysis position is defined in which the analysis chamber of the control valve is completely delimited by the body of the actuator, in particular of the stroke piston, and the valve cage.

In an alternative embodiment, the analysis chamber is delimited by the actuator, in particular the stroke piston, and a housing channel wall at the inlet or outlet of the control valve. This embodiment can be combined in particular with the embodiments described previously, according to which the analysis position corresponds to the closed position. The at least one analysis means may be arranged on the actuator and/or the housing channel wall delimiting the analysis chamber.

According to an embodiment of a control valve combinable with the foregoing, the actuator is adapted as a stroke piston to urge the process fluid out of the analysis chamber as a displacement piston. For example, the displacement stroke piston is designed and adapted to force the process fluid out of the analysis chamber through a filter and/or through an analysis channel. For example, the analysis chamber may be defined by the stroke piston and a valve cage, wherein at least one analysis means in the form of a filter is provided in the valve cage or the stroke piston, designed and adapted to retain process fluid constituents having a particle size greater than a maximum size defined by the filter, such that a process fluid displacement using the displacement stroke piston increases the proportion of large particles in the analysis chamber. The maximum size can be 1 mm or smaller, in particular 100 μm or smaller, preferably 10 μm or smaller, particularly preferably 1 μm or smaller. Alternatively, or additionally, the displacement stroke piston may be designed and adapted to convey process fluid from the analysis chamber through an analysis channel to an analysis means arranged outside the control valve housing. In such an embodiment, the actuator may be used as an actuator for an analysis in addition to its conventional actuating function.

Further, in one embodiment, the control valve may comprise a flushing means for controlled removing of fluid, in particular process fluid and/or a sample process fluid respectively a test volume having at least one amplified biological and/or chemical property, from the analysis chamber. In particular, the flushing for controlled removing of fluid is designed and adapted to remove the fluid to be removed from the analysis chamber without contamination of the process fluid outside the analysis chamber, for example in the remainder of the interior of the valve housing. The flushing may comprise at least one or at least two channels guiding into the inner space of the analysis chamber, which may be referred to as flushing channels, and which are in particular accommodated in at least one retaining web of the valve cage. The flush may be configured and adapted to deliver at least one cleaning fluid and/or process fluid into the analysis chamber through a first flush channel. Additionally, or alternatively, the flushing may be designed and adapted to convey fluid, for example a sample of process fluid having at least one amplified chemical and/or biological property, at least one cleaning fluid and/or process fluid through a second flushing channel out of the analysis chamber, and preferably out of the control valve housing. The flushing may be configured to introduce several different cleaning fluids into the analysis chamber simultaneously, at least partially sequentially, or sequentially.

Alternatively, or additionally, in an embodiment of a control valve, a stroke piston and/or a valve cage, a purification system may be provided comprising at least one radiation source, such as a UV radiation source, designed and adapted to deactivate and/or destroy contaminations, such as germs, for example bacteria or cells, by means of radiation, for example UV radiation, in the process fluid and/or the analysis chamber and/or the test volume.

According to a sixth aspect of the disclosure, an analysis arrangement for determining a chemical and/or biological property of a process fluid in a process plant, for example a brewery, is provided. In particular, the analysis arrangement is provided for determining a biological contamination of the process fluid, such as bacteria or viruses. It should be understood that the analysis arrangement may be designed and adapted for determining a chemical and/or biological property, in particular a contamination, of the process fluid. The analysis arrangement comprises at least one analysis means for interacting with the process fluid. In an exemplary embodiment, the analysis arrangement comprises a plurality of analysis means for interacting with the process fluid. Further, the analysis arrangement comprises at least one actuator, valve cage, and/or control valve. Optionally, the analysis arrangement may comprise an actuator, such as a stroke piston, which may be embodied as previously described, in particular according to the third aspect of the disclosure. Alternatively, or additionally, the analysis arrangement may optionally comprise a valve cage, which may be as described above, in particular according to the first and/or second aspect of the disclosure. Further, the analysis arrangement may optionally comprise a control valve, which may be as described above, in particular according to the fourth and/or fifth aspect of the disclosure. In an exemplary embodiment, the analysis arrangement comprises an analysis chamber. In an exemplary embodiment, the at least one analysis means of the analysis arrangement may be arranged at or in the analysis chamber or directed towards the analysis chamber. In particular, the at least one analysis means of the analysis arrangement is configured and adapted to interact with process fluid in the analysis chamber. In an exemplary embodiment, the at least one analysis means of the analysis arrangement comprises at least one sensor for detecting a chemical and/or biological property of the process fluid. With an analysis arrangement for determining a chemical and/or biological property of the process fluid, comprising a control valve, an actuator and/or a valve cage, a control feedback is possible, so that the process fluid flow adjustable with the control valve is controllable considering the chemical and/or biological property of the process fluid determined by the at least one analysis arrangement.

According to one embodiment of the analysis arrangement, the at least one analysis means comprises a filter for isolating particles in the process fluid, in particular a filter for retaining particles larger than a maximum size defined by the filter. According to one embodiment, the filter may be arranged at an outlet of the analysis chamber to concentrate particles larger than the maximum size within the analysis chamber by means of the filter. Such an embodiment of an analysis arrangement with output filter may be of particular interest for analysis arrangements whose analysis is to be related to a chemical and/or biological property of the process fluid concerning particles larger than the maximum size. Alternatively, the filter may be located at an inlet of the analysis chamber to keep the analysis chamber free of particles larger than the maximum size by means of the filter. Such an embodiment with input filter may be advantageous for an analysis arrangement whose analysis of a biological and/or chemical property of the process fluid is to be undisturbed by large particles. For example, the analysis arrangement may include an analysis means, such as a sensor, that is sensitive to interference and/or damage from large particles.

In an exemplary embodiment of the analysis arrangement, combinable with the foregoing, the at least one analysis means comprises an injector for delivering a reagent into the process fluid for amplifying a property of the process fluid. In an exemplary embodiment, the analysis arrangement comprises a plurality of coordinated analysis means, for example a sensor for detecting or measuring a first property of the process fluid and an injector for supplying a reagent for amplifying that first property of the process fluid. In this manner, an analysis arrangement may be capable of reliably analyzing the otherwise difficult-to-detect first properties of the process fluid. In particular, the reagent may be comprised in the process fluid for amplifying a property relating to a biological contamination, such as bacteria or viruses. In particular, the reagent comprises a staining agent, such as viral staining proteins and/or ethium bromide. The staining agent may be specific to a particular contamination or group of particular contaminations, for example with respect to a particular germ, such as a bacterium, spore, virus, or with respect to a particular group of germs. For example, intercalating reagents such as ethidium bromide are excellent staining agents for staining nucleic acids, for example DNA or RNA, which as carriers of genetic information, can be found in all biological organisms. Ethidium bromide, is a red phenanthridine dye that intercalates in nucleic acids, thereby detectably altering the intensity of UV light-dependent fluorescence emission. Other exemplary intercalating dyes for the detection of biological substances include SYBR Green-I®, SYBR Green-II®, SYBR Gold®, propidium iodide, EvaGreen® dyes, LCGreen® dyes, SYTO® dyes, BEBO dyes, BOXTO dyes, Chromofy™ dyes, TOTO®-1 ((1-1′-[1, 3-propanediylbis[(dimethyliminio)-3, 1-propanediyl]]bis[4-[(3-methyl-2(3H)-benzothiazolylidene) methyl]]-, tetraiodide), and YoPro® (4-[(3-methyl-2(3H)-benzoxazolylidene) methyl]-1-[3-(trimethylammonio)-propyl]-diiodide). Biological binding agents that specifically bind to biological polymers such as proteins, nucleic acids, hydrocarbons and lipids and are provided with signaling functional groups, such as fluorescent dyes, are further suitable as staining agents in the sense of the disclosure. Binding agents for the detection of biological substances include, in particular, proteins that can interact specifically or non-specifically with other biological polymers. In particular, antibodies or nucleic acid aptamers, as well as all antigen-binding derivatives of these substances (for example Fab or scFv fragments), can be highlighted here as being suitable for the disclosure by way of example. Particularly preferred detection methods concern antibody-based so-called immunological detection methods in which a specific binding of an antibody to an antigen is detected.

Additionally, or alternatively, the analysis arrangement optionally comprises at least one analysis means comprising at least one temperature control means for heating and/or cooling the process fluid in the analysis chamber. In an exemplary embodiment, the temperature control means is adapted to the process fluid or a specific property, such as a contamination, of a process fluid such that the temperature control means is designed and adapted to induce a phase transition of at least a portion of the process fluid. In an exemplary embodiment, the portion of the process fluid whose phase transition is inducible with the aid of the temperature control means corresponds to a specific property of the process fluid to be determined, such as a contamination. In an exemplary embodiment, an analysis means equipped with a temperature control means additionally comprises a temperature sensor. With the aid of the temperature sensor, the analysis means equipped with the temperature control means can be capable of monitoring a temperature of the process fluid or of a part of the process fluid as a function of an introduced thermal energy and/or as a function of an extracted thermal energy, in particular in order to characterize a phase transition. The phase transition may be, for example, a phase transition from solid to liquid.

According to one embodiment, the analysis arrangement may provide that the at least one analysis means comprises at least one sensor for detecting a chemical and/or biological property of the process fluid, in particular a biological contamination of the process fluid, such as bacteria or viruses.

According to a further embodiment, the at least one sensor is an optical sensor, for example an infrared sensor. It should be understood that the analysis arrangement may comprise a plurality of analysis means each comprising at least one sensor. Alternatively, or additionally, the at least one optical sensor may be adapted and configured to detect fluorescence emission energy transfer, fluorescence polarization energy transfer, or fluorescence resonance energy transfer. Alternatively, or additionally, the at least one optical sensor may be designed and adapted for fluorescence measurements. Further alternatively or additionally, the at least one optical sensor may be adapted and arranged for fluorescence correlation spectroscopy.

According to another embodiment of an analysis arrangement combinable with the foregoing, the at least one analysis means comprises an ultrasonic sensor directed into the analysis chamber.

According to one embodiment of an analysis arrangement comprising an actuator, in particular a stroke piston, the actuator may comprise a reflector surface cooperating with the analysis means.

The reflector surface may be an optical reflector surface and/or an ultrasonic reflector surface.

According to one embodiment of an analysis arrangement, the at least one analysis means comprises a pH sensor, an electrical conductivity sensor, and/or a magnetosensitive sensor. It should be understood that the analysis arrangement may include multiple analysis means that may include different sensors.

In one embodiment of an analysis arrangement having an analysis means comprising a sensor, the at least one sensor is designed and adapted as a chemical sensor, in particular for determining a concentration of a specific biological substance. The chemical sensor may be enzyme-based, for example. Enzymes are biological proteins that catalyze a chemical reaction of an analyte (product). Such catalyzed chemical reactions may cause detectable changes in the physiochemical properties of an analyse fluid, or may cause directly detectable energy emissions—e.g., detectable light or color changes. Changes in electrostatic potential due to the enzymatically catalyzed reaction are detectable in an enzyme field effect transistor (ENFET).

Additionally, or alternatively, the analysis arrangement may be provided with at least one environmental sensor for sensing a flow property of the process fluid, such as a temperature, pressure, flow rate, or the like. For an analysis arrangement, in order to evaluate a biological and/or chemical property detected using an analysis means, it may be helpful to consider the associated ambient conditions of the process fluid flow. For example, depending on the environmental conditions of the process fluid flow, such as its temperature, different border values or threshold values may be relevant for considering a biological and/or chemical property of the process fluid. For example, when determining a chemical property, such as for measuring electrical conductivity, of the process fluid, preferably water of unknown purity, a temperature sensor may be used as an environmental sensor to analyze the chemical property, such as conductivity, as a function of temperature. At least one ambient sensor may be an UR sensor.

According to an embodiment combinable with the previous ones, the analysis arrangement comprises a control unit adapted to close a control valve when the chemical or biological property of the process fluid analyzed with the at least one analysis means exceeds a threshold value. In particular, the control valve may be embodied as described above, in particular according to the fourth or fifth aspect of the disclosure.

According to the disclosure, there is also provided the use of an analysis arrangement as previously described according to the sixth aspect of the disclosure for monitoring a process fluid flow, in particular a water flow, in a process plant, such as a food processing plant, for example a brewery. The method of use according to the disclosure provides that the process fluid flow is examined with respect to at least one chemical and/or biological property, in particular at least one biological contamination, such as bacteria or viruses. It should be understood that the method of use according to the disclosure may provide that the process fluid flow is investigated with respect to various properties, including at least one, preferably more, chemical and/or biological properties, and optionally with respect to its flow properties.

The disclosure also relates to a method for monitoring a process fluid flow, in particular a water flow, in a process plant, such as a food processing plant, for example a brewery, with respect to a chemical and/or biological property, in particular a biological contamination, such as bacteria or viruses. According to the disclosure, the monitoring method provides that in a control valve for adjusting a process fluid flow of up to at least 1 L/h, a test volume is separated from the rest of the process fluid flow in order to analyze the property at the test volume. In particular, the monitoring method may provide for the use of a control valve according to the fourth or fifth aspect of the disclosure, the use of a stroke piston according to the third aspect of the disclosure, and/or the use of a valve cage according to the first and/or second aspect of the disclosure for adjusting the process fluid flow.

According to an embodiment of the monitoring method according to the disclosure, it is provided that, for singulation, the test volume is led into an analysis chamber of the control valve, which is kept separate, in particular process fluid-tight, from the (remaining) process fluid carrying interior of the control valve housing in at least one operating position of the control valve.

In a further development of the monitoring method, it is provided that the analysis chamber is formed by a movable actuator, in particular a stroke piston, together with the control valve housing, in particular a valve cage. In particular, the analysis chamber can be formed by moving the stroke piston from a receiving position to an analysis position.

According to an embodiment of the monitoring method, the analysis chamber is kept separated in a process-fluid-tight manner from the (remaining) process fluid carrying interior of the control valve housing in at least one closed position and/or in at least one flow position of the control valve.

In one embodiment of the monitoring method, the analysis chamber is fluidically connected to the remaining process fluid-carrying interior of the control valve housing in at least one operating position, in particular the receiving position, in order to lead the test volume into the analysis chamber.

In an exemplary embodiment, during the monitoring process, the chemical and/or biological property of the process fluid flow to be monitored is amplified in the test volume within the analysis chamber. In particular, a reagent is added to the analysis chamber to amplify the property. Amplifying the concentration of a biological organism in the process fluid flow above the detection limit can be achieved, for example, by introducing cultivation media and adjusting cultivation conditions (such as temperature and pH) and then propagating the organisms within the analysis chamber. Nucleic acids can be provided using a polymerase chain reaction (PCR) by introducing PCR reagents such as a polymerase, sufficient nucleotides, and specific primer oligonucleotides.

In particular, the monitoring method may guide the process fluid through a filter to isolate particles in the test volume. In particular, the process fluid can be led through a filter for retaining particles larger than a maximum size defined by the filter. In this process, the process fluid can be discharged from the test volume, in particular with separation of the large particles, or supplied to the test volume, in particular with separation of large particles.

In an exemplary embodiment, the monitoring method compares the property analyzed on the test volume with a permissible value range. The permissible value range can be defined by at least one border value and/or at least one threshold value.

According to a further development of the monitoring method, a flow property of the process fluid, such as a temperature, a pressure, a flow rate or the like, is additionally determined, in particular to determine the permissible value range. The border value and/or the threshold value can be defined depending on an environmental condition of the process fluid or the process fluid flow, in particular a flow property.

According to a further embodiment of the monitoring method, which can be combined with the previous one, if the analyzed property deviates from the permissible value range, the control valve is caused to assume an emergency operating position, such as an emergency open position or an emergency closed position.

According to one embodiment of the monitoring method, the test volume of the process fluid is analyzed within the analysis chamber. At least one analysis means, preferably multiple analysis means, may be used to analyze the process fluid. In particular, the monitoring method may use at least one analysis means at or within the analysis chamber.

According to another embodiment of the monitoring method, which may be combinable with the previous one, the process fluid is at least partially discharged from the test volume through an analysis channel from the analysis chamber, in particular from the control valve housing. Thereafter, the at least partially discharged process fluid is analyzed. The analysis of the process fluid with respect to at least one biological and/or chemical property and, if applicable, at least one flow property can be performed locally at the control valve using analysis electronics and/or can be performed in a centralized or decentralized computing system. The data can be distributed and analyzed via networks, such as cloud solutions. Furthermore, swarm intelligence and/or AI can be used to analyze at least one biological and/or chemical property and, if applicable, a flow property.

### Process Fluid

The process fluid generally refers to a fluid to be processed in the process plant. The process fluid may be gaseous, liquid or a multiphase mixture at least in sections in the process plant. In particular, the process fluid may be or comprise water. In an exemplary embodiment, the process fluid is intended to be brought into contact with the human body. In an exemplary embodiment, the process fluid is a food product, a solution for medical administration, a medical device, a cosmetic product or the like, or a liquid precursor for a food product, medicine, medical device, cosmetic product or the like. The process fluid may be an at least approximately Newtonian fluid. Alternatively, the process fluid may be a non-Newtonian fluid, such as a rheopexic or thixotropic fluid. The process fluid may be characterizable by its properties, particularly its biological and/or chemical properties. Chemical properties of the process fluid relate, for example, to its composition of various elements, compounds, substances, particles, mixtures, and/or phases. Biological property of the process fluid may concern, for example, the loading of the process fluid with biologically active components, such as DNA, RNA, proteins, enzymes, lipids, vitamins, hormones and other messengers, cells, germs, in particular fungi, bacteria, viruses or the like, or the like.

### Process Fluid Flow

Process fluid flow refers to the flow, in at least sections, of the process fluid in the process plant. A process fluid flow may be characterizable at least locally, at a location of the process plant, in particular at a control valve, on the basis of its fluid-dynamic flow properties, such as a flow rate or a flow volume, a process fluid temperature, a process fluid pressure or the like.

### Analysis Means

An analysis means is generally provided to interact with the process fluid. In an exemplary embodiment, the analysis means interacts with the process fluid with respect to at least one biological and/or chemical property. In an exemplary embodiment, the at least one analysis means is adapted and designed to interact with the process fluid with respect to at least one in particular predetermined biological and/or chemical property. At least one analysis means may be adapted and designed to measure at least one or exactly one predetermined biological and/or chemical property of the process fluid. In particular, at least one analysis means may be adapted and designed to detect the presence or absence of a predetermined biological property or a predetermined chemical property of the process fluid, in particular the exceeding of a threshold value with respect to the one predetermined biological property or chemical property.

Alternatively, or additionally, at least one analysis means may be adapted to amplify at least one, in particular predetermined, biological and/or chemical property of the process fluid, for example to increase a concentration of a predetermined component and/or, for example, to separate, in particular to filter out, process fluid constituents having predetermined properties, such as a particle size, an electric charge or the like. In an exemplary embodiment, at least one analysis means is a filter. An analysis means may comprise an enrichment system for at least one germ, such as a bacterium, a virus, or the like. Additionally, or alternatively, an analysis means may comprise a colony counter or another system for quantitatively determining the concentration of a contamination, such as with germs, such as with bacteria, viruses, or the like, in the process fluid. Alternatively, or additionally, at least one analysis means may be a sensor for detecting a chemical and/or biological property of the process fluid. A plurality of analysis means may comprise a plurality of sensors for detecting chemical and/or biological properties of the process fluid.

An analysis means may comprise at least one filter. For example, a filter may be a semi-permeable membrane or may comprise a series of membranes. A filter may comprise at least one capture substrate and/or at least one capture reagent. A filter may comprise a system for separating specific, in particular biological and/or chemical, components from the process fluid, in particular at least one magnet, such as a permanent magnet and/or electromagnet, designed and adapted to separate at least one magnetic substance from the process fluid by means of a magnetic field. Alternatively, or additionally, a filter may comprise a system for singulating at least one specific, in particular biological and/or chemical, component from the process fluid by means of electrophoresis.

An analysis means may comprise an optical sensor. An optical sensor may be realized designed and adapted for fluorescence emission energy transfer, fluorescence polarization energy transfer or fluorescence resonance energy transfer, fluorescence correlation spectroscopy. An optical sensor may comprise a laser diode. Alternatively, or additionally, an optical sensor may comprise an image sensing device, such as a CCD camera. The optical sensor may be equipped with corresponding analysis electronics, for example, for image processing.

### Control Valve

A control valve generally refers to a fitting of a process plant for adjusting a process fluid flow of the process plant. For example, a control valve can be implemented as an open/closed valve that has a predefined closed position and a predefined open position, between which the open/closed valve can switch according to operation. Alternatively, or additionally, the control valve can be designed and adapted to adjust flow characteristics of the process fluid flow within a predefined adjustment range. For example, the control valve may be designed and adapted to adjust a flow property such as a flow rate or flow volume through the control valve, a process fluid temperature upstream and/or downstream of the control valve, a process fluid pressure upstream and/or downstream of the control valve, a process fluid pressure differential across the control valve, or the like. In particular, the control valve may be configured and adapted to continuously or incrementally adjust a flow characteristic of the process fluid flow within a predefined adjustment range. A control valve generally includes a control valve housing, an actuator, an actuator drive, and control and/or regulating electronics. The control valve housing has at least one inlet for the process fluid and at least one outlet for the process fluid, as well as a passage with an opening cross-section between the inlet and the outlet that can be adjusted by means of the actuator. The actuator drive of the control valve is configured and adapted to position the actuator of the control valve within the control valve housing relative to the passage to adjust at least one flow characteristic by positioning the actuator relative to the passage. For example, the actuator drive may be configured to urge the actuator to a closed position closing the passage, urge the actuator to an open position fully releasing the passage, and/or cause the actuator to assume one of a plurality of intermediate positions having different, defined opening cross-sections between the actuator and the passage. The actuator drive can be implemented, for example, as a pneumatic actuator drive, in particular a single-acting or double-acting pneumatic actuator drive, hydraulic actuator drive and/or electromagnetic actuator drive, in particular with or without spring return. The actuator may be mechanically connected to the actuator, for example by means of an actuating rod or an actuating shaft. The control and/or regulation electronics of the control valve are designed and adapted to actuate the actuator drive in order to manipulate a flow property of the process fluid flow by means of the control valve. The control and/or regulation electronics can consider at least one setpoint specification and/or at least one actual value specification with respect to at least one flow property of the process fluid flow in order to provide an actuation signal to the actuator drive. The control valve may be designed and adapted for a process fluid flow, in particular a water flow, of up to at least 1 L/h, wherein this denotes the flow rate of the process fluid flow through the control valve when the control valve is fully open, i.e. in the open position of the control valve. In particular, the control valve is designed and adapted for a process fluid flow rate up to at least 5 L/h, up to at least 10 L/h, up to at least 50 L/h, up to at least 100 L/h, up to at least 500 L/h, or up to at least 1,000 L/h. Let it be understood that this means the process fluid flow under nominal operating conditions. In an intermediate position of the control valve, a correspondingly lower process fluid flow may be adjustable. In a closed position, the process fluid flow may be zero or near zero. In the closed position, the control valve allows process fluid flow from the inlet to the outlet.

### Actuator (Stroke Piston)

An actuator generally refers to a component of the control valve that is movable relative to the control valve housing, particularly a passage, in the control valve. The actuator can be used to adjust the process fluid flow. For example, actuators may be designed and adapted to assume at least two different relative positions within a control valve housing to adjust at least two different process fluid flows, in particular at least one open position in which the actuator allows a process fluid flow through the control valve, in particular a maximum process fluid flow, and at least one closed position or off position in which the actuator allows no process fluid flow, almost no process fluid flow, or a predetermined minimum process fluid flow through the control valve. The actuator may be designed and adapted to assume a plurality of relative positions with respect to the control valve housing to adjust a corresponding plurality of different process fluid flow rates. The various relative positions with process fluid flow rates and the open position may be referred to as flow positions. In a control valve designed as a so-called butterfly valve, the actuator may be implemented, for example, as a plate rotatable relative to the control valve housing. In the case of a control valve designed as a ball valve, the actuator can be implemented, for example, as a rotatable body of rotation with at least one through channel. In the case of a control valve configured as a stroke valve, the control valve member may be implemented, for example, as a stroke piston. A stroke piston generally comprises a cylindrical piston body and an actuating rod that is detachably or non-detachably connected to the piston body. The piston body can have a rotationally symmetrical or mirror-symmetrical shape with respect to an actuating axis. The piston body and the actuating rod may be arranged concentrically, in particular coaxially with respect to each other and the actuating axis, wherein preferably the direction of the actuating axis corresponds to the translatory actuating direction of the stroke piston, which may also be referred to as the stroke direction. The piston body may have a conical cross-section. In an exemplary embodiment, a piston body is frustoconically or conically tapered on the side opposite the actuating rod, wherein in particular the tapering defines a counter sealing surface. The piston body may have a U-shaped or H-shaped cross section. Stroke pistons with a U-shaped or H-shaped cross section can be designed and adapted to cooperate with a corresponding, in particular shape-complementary hollow cylindrical valve cage.

### Valve Cage

A valve cage may be a generally sleeve-shaped and/or hollow cylindrical device. The valve cage may be one-piece or multi-piece. The valve cage is adapted and configured to fully surround and/or implement the passage of a control valve housing. The valve cage may be adapted to be releasably or non-releasably connected or connectable to a control valve housing. The valve cage may be formed as a materially interlocking portion of a control valve housing, for example made by a metal casting process. In an exemplary embodiment, a valve cage is releasably attachable or fastenable to a control valve housing. In an exemplary embodiment, a valve cage is designed to correspond, in particular to complement the shape of, an actuator, in particular a stroke piston. In an exemplary embodiment, the valve cage is designed and adapted to guide a stroke piston translationally according to a predetermined actuating direction, in particular between a closed position or off position and an open position. The valve cage and stroke piston can be matched to one another in such a way that in a closed position an active surface, in particular a counter-sealing surface, of the stroke piston cooperates in a sealing manner with a seating surface, in particular a sealing surface, of the passage, in particular of the valve cage. According to operation, the stroke piston and the valve cage in the control valve can be arranged concentrically, in particular coaxially, with respect to the actuating axis of the stroke piston. In particular, a gap is provided between the stroke piston and the valve cage in the radial direction with respect to the actuating axis. The stroke piston and valve cage can be mounted in radial direction corresponding to a sliding fit or a clearance fit with respect to each other. The valve cage has at least one axial opening corresponding to the passage of the control valve housing and at least one radial opening, preferably a plurality of radial openings, for the process fluid flow. In the case of a control valve with valve cage and stroke piston, the process fluid flow can be adjustable in a predetermined manner depending on the relative position of the control valve with respect to the valve cage. In an exemplary embodiment, depending on a translatory relative position of the stroke piston relative to the valve cage in the direction of the actuating axis, a number and/or a cumulative opening cross-section of the radial opening(s) of the valve cage can be released for the process fluid flow through the stroke piston.

In the following description of exemplary embodiments based on the figures, the same or similar reference numerals, optionally increased by 100 or multiples thereof, are used for the same or similar components of different embodiments.

An analysis arrangement is generally designated by a single-digit reference symbol 1, 2, 3, 4, 5, or 6. A control valve is generally designated by the reference sign 100 or multiples thereof. A control valve configured as a stroke piston generally has a reference designation ending with 30, and a valve cage generally has a reference designation ending with 10.

In the following description of exemplary embodiments based on the figures, only those control valves are shown whose actuator is a stroke piston. It should be understood that an analysis arrangement according to the disclosure may alternatively have a different type of actuator (not shown in more detail).

It is conceivable that, in a process plant, several analysis arrangements and/or control valves with analysis means are arranged parallel to one another or in series one behind the other, in particular in order to carry out different analyses with the aid of the several analysis arrangements and/or control valves with respect to the same process fluid flow.

The operational flow direction of a process fluid in the control valves of the various embodiments of different analysis arrangements shown below can optionally be set with reference to the representation from “right” to “left” (flow-to-close; in short: FTC) or alternatively from “left” to “right” (flow-to-open; in short: FTO). A control valve may be specifically designed and adapted for flow-to-open and/or flow-to-close. For the sake of easy readability of the application, the flow direction Flow-to-Open, from “left” to “right” is assumed in the following by way of example, and in this sense terms referring to the flow direction, such as “inlet” and “outlet” of the control valve, are used.

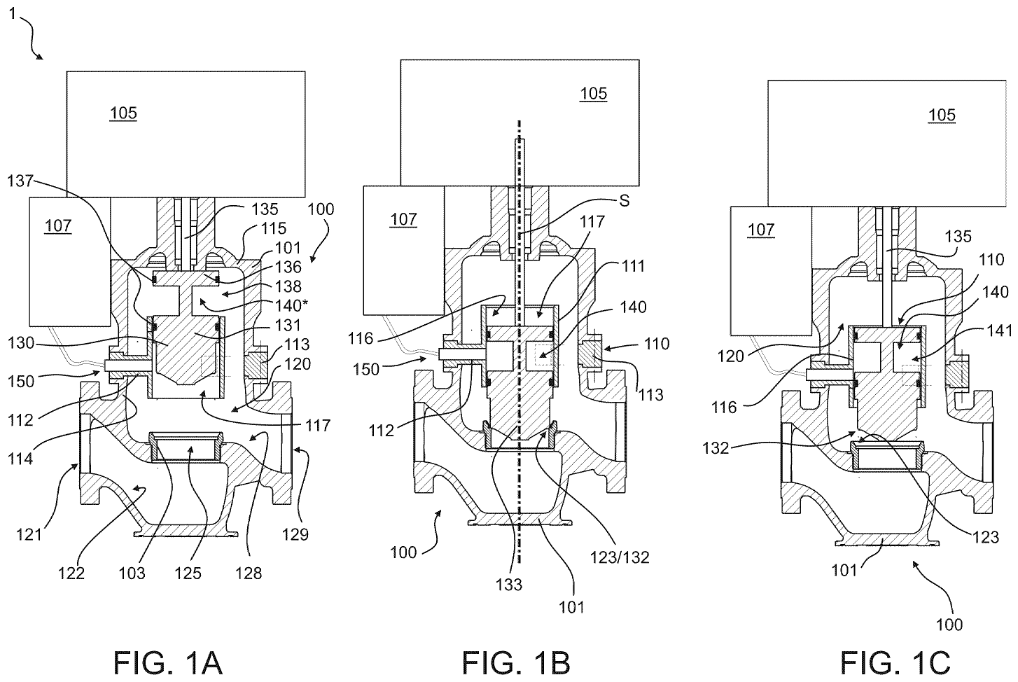

FIGS. 1A, 1B, and 1C show a first exemplary embodiment of an analysis arrangement 1. The analysis arrangement 1 comprises a control valve 100. The control valve 100 comprises a stroke piston 130, which is translationally movable in the control valve housing 101 according to an actuating axis S. The control valve housing 101 has a valve cage 110 arranged in the interior 120 of the control valve housing 101, in which the stroke piston 130 is guided so as to be translationally movable.

The valve cage 110 is held in the interior 120 of the control valve 100. In the embodiment shown in FIGS. 1A to 1C, the valve cage 110 comprises a sleeve body 111, a retaining flange 113 and a retaining web 112 connecting the sleeve body to the retaining flange 113. The valve cage 110 mounted in the control valve 100 forms part of the control valve housing 101. The retaining flange 113 of the valve cage 110 is held between a collar portion 114 and a cover portion 115 of the control valve housing 101.

The actuator drive 105, for example a pneumatic actuator drive, of the control valve 100 may be attached to the cover section 115, for example directly (as shown) or indirectly, by means of a lantern or the like. The actuator 105 drive is connected to the stroke piston 130 by means of an actuator rod 135 to move the stroke piston 130 to an operating position, to maintain stroke piston 130 in an operating position, and/or to communicate an actuating action to the stroke piston 130. The actuator 105 is connected to control and/or regulation electronics 107 in signal transmitting manner. The control electronics 107 is designed and adapted to provide a control signal to the actuator drive 105 to cause the actuator drive 105 to communicate a particular actuating operation to the stroke piston 130, to imprint actuating motion, and/or to provide actuating force.

In the inside 120 of the control valve housing 101, a process fluid can, at an open position, such as the open position according to FIG. 1A or the intermediate position according to FIG. 1C, flow from the inlet 121 through the passage 125 to the outlet 129. The process fluid guiding interior 120 of the control valve housing 101 is delimited at the inlet 121 or outlet 129 of the control valve 100 by a respective housing channel wall 122 or 128. In the closed position shown in FIG. 1B, a sealing surface 123 of the valve housing 101 cooperates with a counter sealing surface 132 of the control piston 130 to seal the control valve 100 at the passage 124 in a process fluid-tight manner. In the illustrated embodiment, the sealing surface 123 is formed to a valve seat 103 separate from the valve cage 110. The valve seat 103 forms part of the valve housing 101.

With the aid of the control valve 100, the process fluid flow can be adjustable, for example, depending on an opening width between the control piston 130 and valve seat 103. In the open position, the maximum flow rate of process fluid through the control valve 100 is generally at least 1 L/h. The maximum flow rate of the control valve 100 may be defined by the operational flow characteristics, for example the pressure, viscosity, temperature, etc., of the process fluid flow at inlet 121 and/or outlet 129, the geometry of the control valve housing 101 and the opening width in the open position. In the closed position, the flow of process fluid through the control valve 100 is generally 0 L/h or nearly 0 L/h. The control valve 100 is configured and adapted to assume one or more intermediate positions (corresponding approximately to FIG. 1C), and to set a process fluid flow rate below the maximum flow rate. Control and/or regulating electronics 107 may be provided for this purpose.

The foregoing description of the control valve 100 and its functionality for adjusting a process fluid flow applies mutatis mutandis to the control valves 200, 300 according to the second and third embodiments of an analysis arrangement 2, 3. The foregoing description of the control valve, with the exception of the reference to the valve cage, is also applicable to the control valves 400, 500 and 600 of the fourth to sixth embodiments of an analysis arrangement 4, 5, 6.

FIG. 1B shows the control valve 100 in the analysis position, in which the valve piston 130 and the valve cage 110 together define an analysis chamber 140. The analysis chamber 140 is separated from the rest of the interior 120 of the control valve housing 101 in a process fluid tight manner. A test volume 141 of process fluid is received within the analysis chamber 140.

FIG. 1B shows an example of an analysis means 150 that can interact with the process fluid of the test volume 141 within the analysis chamber 140. The analysis means 150 is housed within the retaining web 112 and extends radially to the actuation axis S through the inner cylinder wall 116 defined by the sleeve body 111, which fully surrounds the inner space 117 of the valve cage 110. In the analysis position, the inner cylinder wall 116 of the valve cage 110 fully delimits the analysis chamber 140 radially relative to the actuation axis S. In the first and second axial directions relative to the actuation axis S (according to the illustrated embodiment, i.e. upward and downward), the analysis chamber 114 is delimited by the body 133 of the stroke piston 130. In axial directions relative to the actuating axis S on both sides, fully cylindrical, disk-like sections 131 and 136 of the stroke piston 130 surround the analysis chamber 140. In radial direction R between the respective disk section 131 and 136 of the stroke piston 130 on the one hand and the inner cylinder wall 116 of the valve cage 110 on the other hand, ring seals 137 are arranged so that in the analysis position the analysis chamber 140 is separated from the rest of the interior 120 of the control valve housing 101 in a process fluid-tight manner.

FIG. 1A shows the control valve 100 in the receiving position. In the receiving position, a receiving chamber 140* corresponding to the analysis chamber 140 communicates, by means of a fluidic connection 138, with the interior 120 of the control valve 100 through which process fluid flows. In the typical control valve 100, the fluidic connection is implemented by the radially outer, full-circumference opening 138 of the valve piston 130 between the disk sections 131 and 136. In the receiving position, process fluid can flow from the interior 120 of the control valve 100 through the opening 138 into the receiving chamber 140*. The process fluid in the receiving space 140* can be separated from the remaining process fluid in the interior 120 of the control valve housing 101 as a test volume 141, by moving the valve piston 130 to the analysis position, in which the sleeve body of the valve cage 110 together with the body 131 of the valve cage 130 delimits the analysis chamber 114.

In the first embodiment of an analysis arrangement 1 comprising a control valve 100, the closed position of the control valve 100 corresponds to its analysis position (FIG. 1B) and the open position corresponds to its receiving position (FIG. 1A). For example, as shown in Figure 1C, the control valve 100 may be designed and adapted to assume at least one intermediate position between the open position and the closed position, in which, as shown here, the analysis chamber 114 is separated from the process fluid inside 120 of the valve housing 1 in a process fluid-tight manner, as in the analysis position. Thereby, a test volume 141 can be maintained within the analysis chamber 114 while the control valve 100 can assume a number of different operating positions, including the closed position and at least one intermediate position, and provide a respective adjustment of the process fluid flow. This can be advantageous if, as a result of an analysis, a closed position of the control valve 100 may need to be approached quickly or immediately if, by means of the analysis, an exceedance of critical threshold values with respect to at least one biological and/or chemical property of the process fluid is detected.

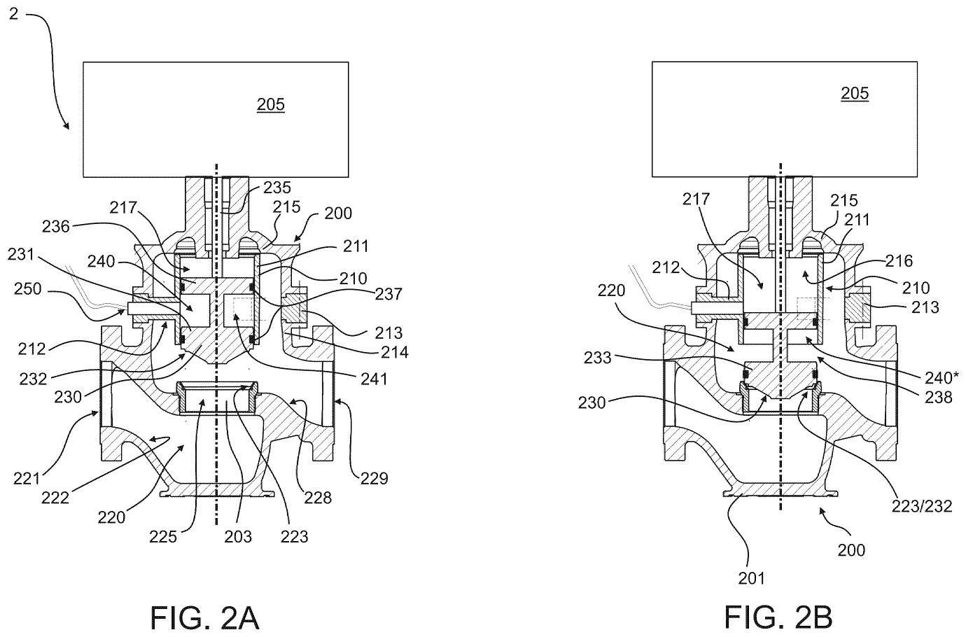

FIGS. 2A and 2B show a second embodiment of an analysis arrangement 2 comprising a control valve 200. The structure of the control valve 200 is substantially the same as the structure of the control valve 100. The control valve 200 comprises a control valve housing 201 having a valve seat 203 defining a passage 225 between an inlet 221 and an outlet 229 of the control valve housing 201 for the process fluid flow. The control valve housing 201 is provided with a valve cage 210 secured by a flange portion 213 between a collar portion 214 and a cover portion 215 of the valve housing 201. Also attached to the cover section 215 is an actuator 205 drive, for example a hydraulic actuator drive, which can actuate the valve piston 230 of the control valve 200 via an actuator rod 235. The valve piston 230 is guided in the valve cage 210. In the analysis position of the control valve 200, at least one analysis means 250 can interact with the test volume 241 of process fluid within the analysis chamber 240.

Unlike the previously described control valve 100, in the control valve 200 the analysis position shown in FIG. 2A corresponds to the open position and the receiving position shown in FIG. 2B corresponds to the closed position of the control valve 200. In the closed position shown in FIG. 2B, as well as in any intermediate positions not shown between the closed position and the open position shown in FIG. 2A, the valve piston 230 is still in a receiving position in which the receiving chamber 240* communicates with the rest of the interior 220 of the control valve housing 201 via a fluidic connection 238.

To perform an analysis with the analysis chamber 240, the control valve 200 requires the valve piston 230 to at least temporarily assume an operating position in which the passage 225 is fully open and process fluid flow can flow through the control valve 200 according to its maximum flow rate. In the closed position or an operationally intermediate position close to the closed position, in which the process fluid flow can be controlled or regulated with the aid of the control valve 200, for example with respect to a pressure reduction via the control valve 200 or a target flow rate, no closed analysis chamber 240 is formed by the valve piston 230 and the valve cage 210. This can be advantageous in processes where a test volume is to be extracted from a process fluid flow as close as possible to its nominal flow characteristics and/or in processes where approaching the closed position is to be avoided except in special individual cases, wherein the valve piston is operationally predominantly near or in the open position.

With reference to the exemplary embodiment of an analysis arrangement 2 according to FIGS. 2A and 2B, it should be understood that the valve cage 210 is considered to be part of the valve housing 201. The valve cage 210 forms a rigid part of the valve housing 210 regardless of the operating positions of the control valve 200, or rather of the valve piston 230. It is readily conceivable that, in a control valve according to the disclosure, instead of the part of the interior 220 of the valve housing 201 circumferentially surrounding the valve cage 210, which is traversed by process fluid, the cylinder inner wall 216 could be formed directly by the inner side of the collar and/or cover section 214, 216 facing the process fluid, which also define part of the outer side of the valve housing 201 (not shown in detail).

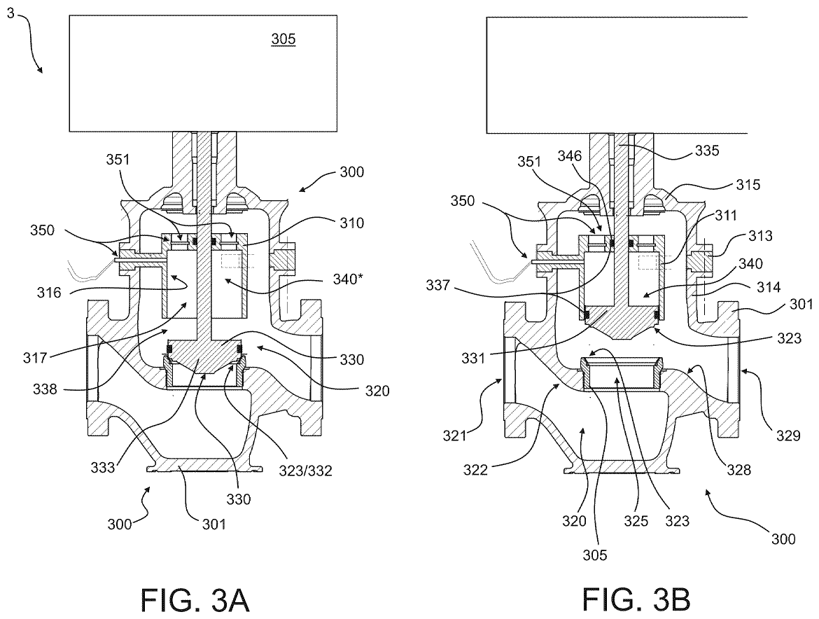

FIGS. 3A to 3D show a third embodiment of an analysis arrangement 3. In the analysis arrangement 3, the control valve 300 comprises a valve cage 310 and a valve piston 330. Similar to the second embodiment of the analysis arrangement 2, the open position corresponds to an analysis position and the closed position corresponds to a receiving position. Essentially, the analysis arrangement 3 according to the third embodiment differs from the second embodiment of an analysis arrangement 2 described previously with respect to FIGS. 2A and 2B by the design of the valve piston 330 and the valve cage 310.

FIG. 3B shows a first analysis position in which the actuating piston 330 delimits the analysis chamber 340 together with the valve cage 310. The analysis chamber is delimited radially with respect to the actuating direction S by the inner cylinder wall 316 of the sleeve body 311 of the valve cage 310. In the first axial direction, downwards, the analysis chamber 340 is delimited by a disk section 331 of the valve piston 330. In contrast to the two previous embodiments, the actuating rod 335 is provided only with this one disk section 331, which has the counter-sealing surface 332 on its side opposite to the analysis chamber wall. In the second axial direction, upward, the analysis chamber 340 is formed by a disk section 346 of the valve cage 310. The actuating rod 335 is guided in the direction of the actuating axis S through the valve cage disk section 346. A ring seal 337 is arranged between the valve cage disk section 346 and the actuating rod 335. Another ring seal 337 is provided between the actuator piston disk section 331 and the cylinder inner wall 316. As in the previous embodiments, the respective ring seals 337 and 347 effect a seal in the gap between the parts that are movable relative to one another, on the one hand the cage 310 (here with disk section 346) fixed stationarily to the rest of the valve housing 301 and on the other hand the movable actuator, i.e. its disk section 331 and actuating rod 335.

The valve cage 310 has two filters 351, which form part of the boundary of the analysis chamber 340 with respect to the rest of the interior 320 of the control valve housing 301. The valve piston 330 is configured as a displacement piston. The displacement piston 330 can be moved further into the valve cage 310 in the direction of the actuation axis S from the position shown in FIG. 3B. As the displacement piston 330 moves into the inner space 317, for example from the position shown in FIG. 3B to the position shown in FIG. 3C, the displacement piston 330 forces process fluid from the analysis chamber 340 out through the filter 351 into the remainder of the interior 320 of the control valve 300 surrounding the valve cage 310. The filter 351 is designed and adapted to retain particles larger than a predetermined maximum size. In the embodiment shown, this results in particles greater than or equal to the maximum size being retained within the analysis chamber 340 when process fluid is displaced from the inner space 317 of the valve cage 310 by the displacement piston 330. The concentration of large particles greater than or equal to the maximum size defined by the filter 351 in the process fluid within the analysis chamber 340 is thus increased. Biological and/or chemical properties of the process fluid manifested in the relatively large particles can thus be more easily determined within the analysis chamber 340 using one or more analysis means 350.

It should be understood that in another embodiment or mode of operation (not shown in detail), a displacement piston can be moved from a position close to the filter, for example according to FIG. 3C, to a position away from the filter, for example according to FIG. 3B, to draw process fluid from the control valve housing 301 through the filter 351 into the inner space 317 and thereby into the analysis chamber 340 of the valve cage 310, wherein relatively large particles larger than or equal to the maximum size defined by the filter 351 are retained outside the analysis chamber 340 in the interior 320 of the control valve housing 301 surrounding the valve cage 310.

FIG. 3D shows a cross-sectional view through an analysis chamber 340, wherein no actuator is shown within the valve cage 310 for case of reading. The cross-sectional view extends through a plane in which the valve cage 310 has three retaining webs 312 that connect a hollow cylindrical sleeve body 311 of the valve cage 310 to an outer circumferential retaining flange 313, which can be used to secure the valve cage 310 to the remainder of the valve housing 301. A corresponding cross-sectional view could also be related to one of the other valve cages 110 or 210 described previously.

The hollow cylindrical sleeve body 311 fully surrounds a cylindrical inner space 317 radially. Radially outside the sleeve body 311 extends a remaining interior 320 of the control valve housing 301, which is separated from the inner space 317 thereof by the sleeve body 311 of the valve cage 310.

Various analysis means 350 are arranged in the retaining webs 312. For example, one analysis means 350 may comprise an optical sensor 371, such as an infrared sensor. Another analysis means 350 may include an injector 361 that can be used to deliver a reagent into the analysis chamber 340 to amplify a biological and/or chemical property of the process fluid to be determined. For example, the reagent may be a colorant that, when encountered with a predetermined biological and/or chemical component or contamination of the process fluid, causes a particular coloration of the process fluid or the process fluid test volume 341 disposed in the analysis chamber 340 that is detectable using the optical sensor 371.

Various analysis means 350 are disposed within the plurality of webs 312 around the periphery of the analysis or holding flange 313. Sufficient space is provided within each holding web 312 for the application of at least one analysis means 350, possibly multiple analysis means per holding web (not shown in more detail). An analysis means 350 may be stationarily arranged at the flange 313 and accessible from outside the control valve housing 301, for example for signal transmission lines. The respective analysis means 350 protrudes through the support web 312 into the analysis chamber 340 and, if applicable, into the process fluid received therein.

Alternatively, or additionally, an analysis means 350 can be implemented as a chemical sensor, for example as an enzyme field effect transistor, which can determine the concentration of at least one predetermined, in particular biological component or contamination of the process fluid or of the test volume 341 arranged in the analysis chamber 340.

A valve cage may, for example, be provided with a plurality of flushing channels as well as, if necessary, a pump (not shown in more detail), for example, in the embodiment according to FIGS. 2A and 2B, after the test volume 241 in the analysis chamber 240 has been tested; to withdraw the test volume 241 consumed by the test from the analysis chamber 240 and, if necessary, to dispose of it without returning the test volume 241 to the process fluid flow inside 220 of the control valve housing 201. A valve cage with a flush typically includes at least one outlet flush channel and at least one supply flush channel (not shown in detail). Through the at least one supply flush channel, the analysis chamber 240 may be flooded with fresh process fluid and, optionally, at least one cleaning fluid for cleaning the analysis chamber 240. It may be useful to house at least one flushing channel in at least one support web 312. The flushing channel may be configured to use a plurality of different cleaning fluids to clean the analysis chamber 240.

Additionally, or alternatively, at least one analysis channel 360 may be provided to convey process fluid from the analysis chamber 340 to the outside, in particular outside the control valve housing 301. In an exemplary embodiment, an analysis channel 360 is provided with a check valve 362 to prevent backflow of, in particular, contaminated process fluid back into the analysis chamber 340. The analysis channel 360 guides from the control valve housing 301 to an external analysis means 354 arranged outside the control valve housing 301, which in particular may be arranged in or at an additional external analysis chamber 344 external to the valve housing. The use of an external analysis means 354, in particular with an external analysis chamber 344, may be useful for using an analysis means 354 that is incompatible with the environmental conditions encountered in the control valve 300 or whose integration into the control valve 300 does not seem desirable from an economic point of view.

A pump 366 may be provided to deliver the process fluid through the analysis channel 360 to the external analysis means 354. Alternatively, or additionally, the displacement piston 330 may be designed and adapted to deliver process fluid through an analysis channel 360 to the outside, in particular outside the control valve housing 301, to an external analysis means 354. It should be understood that instead of the single external analysis means 354 shown in FIG. 3D, two or more external analysis means may be provided to interact with the process fluid in or out of the analysis channel 360. The external analysis means may generally be the same analysis means previously described for analysis means capable of interacting with process fluid within the analysis chamber 340. Process fluid may be either disposed of or guided back into the process fluid flow from the analysis channel 360 and any external analysis chamber 344 connected thereto. For example, an external analysis chamber 344 may include a temperature generator and controller and determination of solid to liquid phase transition.

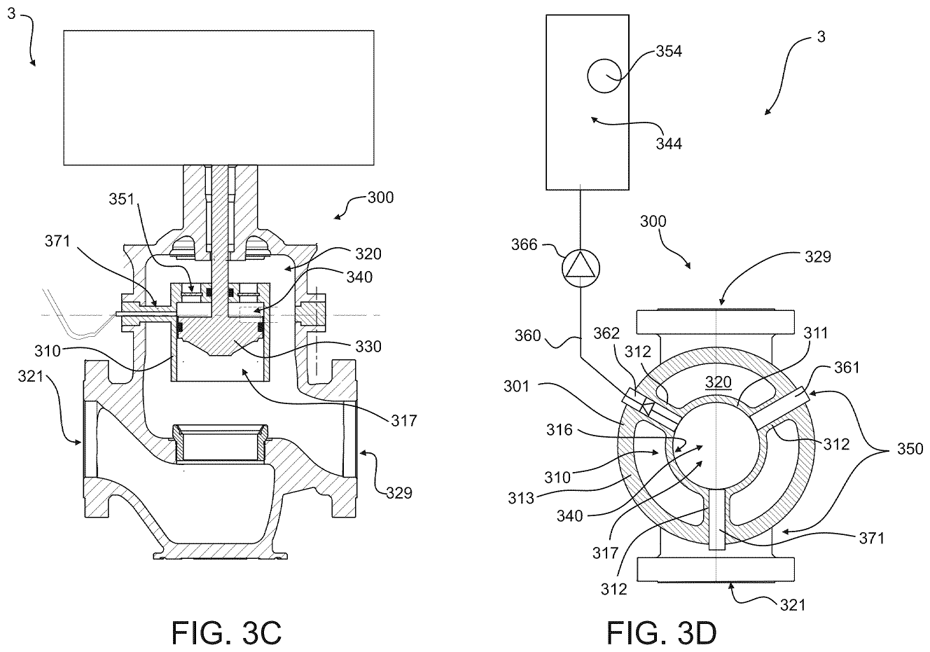

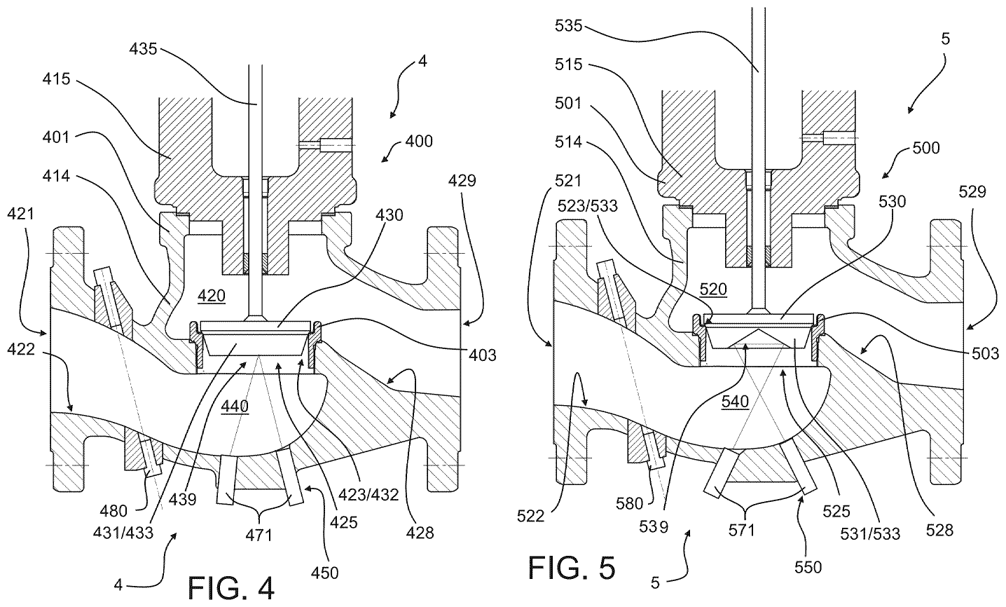

In the analysis arrangement 4 according to FIG. 4, the control valve 400 is designed without a valve cage, as is the control valve 500 of the analysis arrangement 5 according to FIG. 5.

An environmental sensor 480 is arranged at the inlet 421 of the control valve 400, which is designed and adapted to determine at least one flow property, for example a flow rate or flow velocity, of the process fluid flow in the control valve 400.

In the analysis arrangement 4, in the closed position of the control valve 400, the analysis chamber 440 is delimiting by the disk-like body 433 of the stroke piston 430 and the valve channel wall 422 at the inlet 421 of the control valve housing 401. The analysis means 450 of the analysis arrangement 4 comprises two ultrasonic transducers 471, which transmit an ultrasonic measurement signal via a reflector 439 at the lower, inlet-side outer side of the stroke piston 430.

The analysis means 450 could include an optical sensor instead of or in addition to an ultrasonic sensor 471. In the analysis chamber 440 formed at the inlet 421 of the control valve housing 401, a chemical and/or biological property of the process fluid can be analyzed when the control valve 400 is in the closed position. If the chemical and/or biological property of the process fluid is outside a permissible value range, the control valve 400 may be caused to remain in the closed position.

The analysis arrangement 5 corresponds essentially to the analysis arrangement 4. In the case of the control valve 500, the stroke piston is designed with a concave, conical reflector surface 539 on its inlet-side outer side. The measurement signals from the ultrasonic or optical sensor 571 of the analysis means 550 are deflected several times with the aid of the concave reflector surface 539, as shown schematically in FIG. 5, so that an extended signal path extends from the measurement signal emitter to a measurement signal receiver of the optical sensor 571.

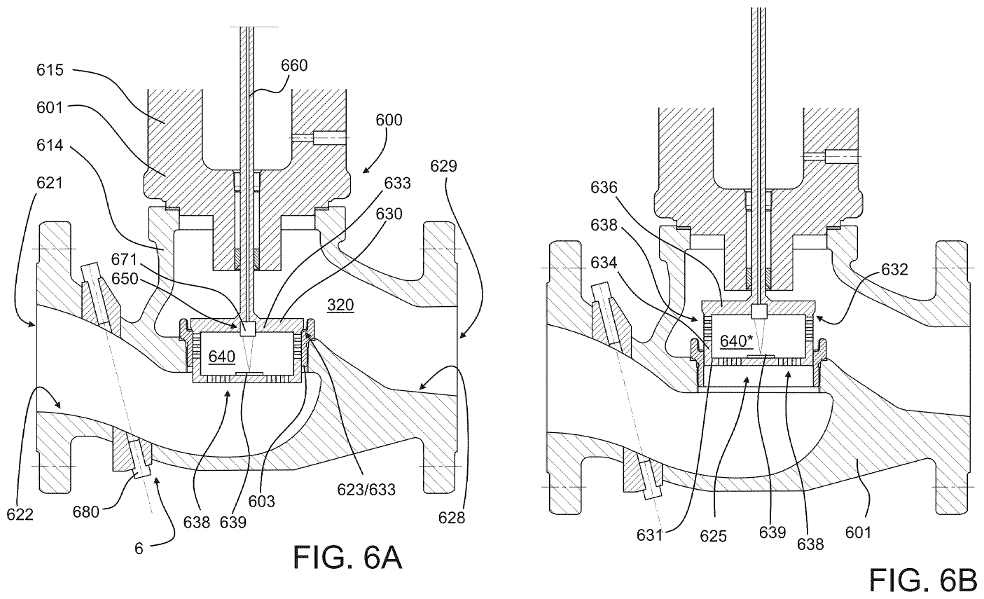

FIGS. 6A and 6B show another alternative embodiment of an analysis arrangement 6. The analysis arrangement 6 does not require a valve cage, but may alternatively be embodied with a valve cage that surrounds and guides the actuator (not shown). An ambient sensor is provided at the inlet 621 of the control valve 600 for sensing at least one flow characteristic of the process fluid. In the analysis arrangement 6, the analysis chamber 640 is formed in an internal cavity of the valve piston 630. In the axial direction, the analysis chamber 640 is delimited on both sides by disk sections 631, 636. In the radial direction, the analysis chamber 640 is delimited by a sleeve wall 634. The valve piston 630 is composed of the disk sections 631, 636 and the sleeve wall 634. On the outside of the sleeve wall 634 in the second positioning direction (top), the counter-sealing surface 632 is provided, with which the valve piston 632 can cooperate in a sealing manner with the sealing surface 623 of the valve seat 603 in the closed position shown in FIG. 6A. An actuator rod 635 is fixedly attached to the upper disk section 636, via which the actuator piston 630 is connected to the actuator (not shown in more detail).

Within the positioning piston 630, an optical sensor 671 is arranged at the periphery of the analysis chamber 640 as analysis means 650, which cooperates with a reflector surface 639 at the opposite lower disk section. The sensor 671 may form an ultrasonic transducer, for example. Additionally, or alternatively, an analysis channel 660 can guide out of the analysis chamber 640, in particular out of the control valve housing 601 to an external analysis means and/or external analysis chamber (not shown in detail).

FIG. 6B shows an open position of the control valve 600. In the open position shown, process fluid flow can flow from the inlet 621 to the outlet 629 through the passage 625 of the control valve housing 601. Additionally, the process fluid flow must flow through at least one of a plurality of through-holes 638 on the lower disk portion 631 into the receiving chamber 640* corresponding to the analysis chamber 640 and out of the receiving chamber 640* through the through-hole 638 in the circumferential sleeve wall 634. It is conceivable that an analysis in the receiving chamber 640* is at least limitedly feasible with the least one analysis means 650.

At the inlet 621 of the control valve 600, an ambient sensor 680 is provided for determining at least one flow property of the process fluid flow, with the aid of which an analysis can be carried out, in particular in the open position, with the aid of the analysis means 650, considering the present flow properties. Alternatively, or additionally, the at least one ambient sensor 680 may be provided to determine whether the control valve 600 is in the closed position as shown in FIG. 6A so that the analysis chamber 640 does not experience flow. The ambient sensor 680 may form an UR sensor.

The features disclosed in the foregoing description, figures, and claims may be significant, both individually and in any combination, in implementing the disclosure in the various embodiments.

### Reference List

1, 2, 3, 4, 5, 6 Analysis arrangement
100, 200, 300, 400, 500, 600 Control valve
101, 201, 301, 401, 501, 601 Control valve housing
103, 203, 303, 403, 503, 603 Valve seat
105, 205, 305 Actuator drive
107 Control and/or analysis electronics
110, 210, 310 Valve cage
111, 211, 311 Sleeve body
112, 212, 312 Retaining web
113, 213, 313 Retaining flange
114, 214, 314 Collar section
115, 215, 315 Cover section
116, 216, 316 Cylinder inner wall
117, 217, 317 Inner space
120, 220, 320, 420, 520, 620 Interior
121, 221, 321, 421, 521, 621 Inlet
122, 222, 322, 422, 522, 622 Valve channel wall
123, 223, 323, 423, 523, 623 Sealing surface
125, 225, 325, 425, 525, 625 Passage
128, 228, 328, 428, 528, 628 Housing channel wall
129, 229, 329, 429, 529, 629 Outlet
130, 230, 330, 430, 530, 630 Stroke piston
131, 231, 331, 431, 531, 631 Full cylindrical disk section
136, 236, 636 Fully cylindrical disk section
132, 232, 332, 432, 532, 632 Counter sealing surface
133, 233, 333, 433, 533, 633 Body
141, 241, 341 Test volume
135, 235, 335, 435, 535, 635 Actuator rod
137, 237, 337 Ring seal
138, 238, 338, 638 Opening/fluidic connection (receiving position)
140, 240, 340, 440, 540, 640 Analysis chamber
140*, 240*, 340*, 640* Receiving chamber (Receiving position)
150, 250, 350, 450, 550, 650 Analysis means
360 Analysis channel
362 Check valve
354 External analysis means
344 External analysis chamber
366 Pump
351 Filter
Injector 361
Optical sensor 371, 471, 571, 671
Reflector 439, 539, 639
Ambient sensor 480, 580, 680
634 Sleeve wall
S Actuator axis

1. A valve cage for guiding an actuator in a control valve for adjusting a process fluid flow, the valve cage comprising:
a body configured to receive the actuator; and
a retainer configured to support an analyzer configured to interact with the process fluid, wherein the control valve includes a sensor configured to detect a chemical and/or biological property of the process fluid.

2. The valve cage according to claim 1, wherein:
the body comprises a sleeve body defining an inner space configured to receive the actuator, the sleeve body being form-fitted to the actuator, wherein the analyzer is configured to interact with the process fluid in the inner space of the sleeve body; and
the valve cage further comprises at least one analysis channel configured to communicate the process fluid from the inner space to the analyzer outside of a control valve housing of the control valve.

3. (canceled)

4. The valve cage according to claim 2, wherein the valve cage further comprises a pump configured to convey the process fluid from the inner space of the valve cage and the control valve housing to the analyzer.

5. The valve cage according to claim 2, wherein the retainer of the valve cage comprises a radial retaining web configured to attach to the control valve, the analyzer and/or the at least one analysis channel being accommodated in the retaining web.

6. A stroke piston for a control valve for adjusting a process fluid flow, the stroke piston comprising:
a counter sealing surface adapted to a sealing surface of the control valve; and
a body configured to at least partially delimit at least one analysis chamber configured to receive the process fluid, wherein the control valve has a sensor for detecting a chemical and/or biological property of the process fluid.

7. The stroke piston according to claim 6, further comprising an analyzer arranged on the stroke piston such that the analyzer is configured to interact with process fluid received within the at least one analysis chamber.

8. (canceled)

9. The stroke piston according to claim 6, wherein the body is a cylindrical body configured to delimit, in an axial stroke direction, the at least one analysis chamber being radially open, and wherein: the cylindrical body surrounding the at least one analysis chamber in a process fluid-tight manner on both sides in the axial stroke direction, and/or the at least one analysis chamber is closed by the cylindrical body in a process-fluid-tight manner on a first side in the axial stroke direction and is open on a second side in the axial stroke direction, the cylindrical body having a wall with at least one through-opening on the second side.

10. (canceled)

11. The stroke piston according to claim 6, wherein the stroke piston has:
at least one analysis channel including a check valve and being configured to communicate process fluid from the at least one analysis chamber to an analyzer outside a control valve housing of the control valve; and/or
a pump configured to convey the process fluid out of the at least one analysis chamber and the control valve housing to the analyzer.

12. (canceled)

13. A control valve for a process fluid flow, comprising:
a control valve housing; and
an actuator configured to be displaceable relative to the control valve housing,
wherein the actuator and the control valve housing are adapted to each other such that the actuator, in at least one operating position, assumes an analysis position, in which the actuator together with the control valve delimits an analysis chamber for receiving process fluid, on which an analyzer is arranged and configured to interact with the process fluid.

14. The control valve according to claim 13, further comprising:
at least one analysis channel with a check valve and configured to communicate process fluid from the at least one analysis chamber to the analyzer that is positioned outside the control valve housing; and
a pump configured to convey, using the at least one analysis channel, the process fluid out of the at least one analysis chamber and out of the control valve housing to the analyzer.

15. (canceled)

16. The control valve according to claim 13, wherein:
the actuator in the control valve is configured to assume, as operating positions, a closed position and at least one flow position, the closed position or the flow position corresponding to the analysis position;
the actuator and the control valve are matched to one another such that the actuator, in at least one operating position, assumes a receiving position that is different from the analysis position, in which the actuator together with the control valve forms a fluidic connection between a region of the control valve through which fluid flows and a receiving space in the actuator and/or the control valve housing, wherein the receiving position corresponds to the closed position and/or the at least one flow position of the control valve;
the analyzer is arranged on a wall delimiting the at least one analysis chamber;
the control valve housing comprises a valve cage configured to guide the actuator, the at analysis chamber being cooperatively delimited by the actuator and the valve cage;
the at least one analysis chamber is delimited by the actuator and a housing channel wall at an inlet or outlet of the control valve;
the actuator is configured to force, as a displacement piston, the process fluid out of the at least one analysis chamber; and/or
the control valve comprises a flush configured to controllably remove fluid from the at least one analysis chamber without contamination of the process fluid outside the at least one analysis chamber.

17-22. (canceled)

23. An analysis arrangement for determining a chemical and/or biological property of a process fluid, comprising:
at least one analyzer configured to interact with the process fluid; and
an actuator, a valve cage, and/or a control valve.

24. The analysis arrangement according to claim 23, wherein the at least one analyzer comprises:
a filter configured to isolate particles in the process fluid and/or retain particles larger than a maximum size defined by the filter;
an injector configured to supply a reagent into the process fluid for amplifying a property of the process fluid, the reagent including a staining agent; and/or
a temperature controller configured to heat and/or cool the process fluid in the at least one analysis chamber to induce a phase transition of at least part of the process fluid.

25-26. (canceled)

27. The analysis arrangement according to claim 23, wherein:
the at least one analysis means comprises at least one sensor for detecting a chemical and/or biological property of the process fluid;
the at least one sensor is an optical sensor and/or is designed and adapted for detecting fluorescence emission energy transfer, fluorescence polarization energy transfer or fluorescence resonance energy transfer, for fluorescence measurements, and/or for fluorescence correlation spectroscopy;
the at least one analysis means comprises an ultrasonic sensor directed into the analysis chamber;
the actuator comprises a reflector surface cooperating with the analysis means; and/or
the at least one analysis means comprises a pH value sensor, an electrical conductivity sensor and/or a magnetosensitive sensor.

28-31. (canceled)

32. The analysis arrangement according to claim 23, wherein:
the at least one sensor is a chemical sensor configured to determine a concentration of a specific biological substance;
further comprising at least one ambient sensor configured to detect a flow property of the process fluid; and/or
further comprising a controller configured to close a control valve in response to the chemical or biological property of the process fluid exceeding a threshold value.

33-35. (canceled)

36. A method for monitoring a process fluid flow with respect to a chemical and/or biological property, the method comprising:
separating a test volume from remaining process fluid flow in a control valve according to claim 13 for adjusting the process fluid flow of up to at least 1 L/h; and
analyzing the chemical and/or biological property of the test volume.

37. The method according to claim 36, wherein:
the test volume is led, for separation, into an analysis chamber of the control valve, the analysis chamber being kept separate from the process fluid-carrying interior of the control valve housing in at least one operating position of the control valve in a process fluid-tight manner;
the analysis chamber is formed by a movable actuator together with the control valve housing;
the analysis chamber is kept separate from the process fluid-carrying interior of the control valve housing in at least one closed position and/or at least one flow position of the control valve in a process fluid-tight manner; and/or
the analysis chamber is fluidically connected to the process fluid-carrying interior of the control valve in at least one operating position in order to lead the test volume into the analysis chamber.

38-40. (canceled)

41. The method according to claim 36, further comprising:
enhancing the monitoring of the chemical and/or biological property of the process fluid flow in the test volume within an analysis chamber; and/or
adding a reagent to the analysis chamber to amplify the chemical and/or biological property.

42. (canceled)

43. The method according to claim 36, further comprising:
guiding the process fluid through a filter configured to retain particles larger than a maximum size defined by the filter to isolate particles in the test volume, the process fluid being discharged from the test volume or being supplied to the test volume;
comparing the property analyzed on the test volume with a permissible value range determined based on a flow property of the process fluid; and/or
in response to a deviation of the analyzed chemical and/or biological property from the permissible value range, causing the control valve to assume an emergency operating position including an emergency open position or an emergency closed position.

44-46. (canceled)

47. The method according to claim 36, wherein:
the test volume of the process fluid is analyzed within an analysis chamber; or
process fluid is at least partially discharged from the test volume through an analysis channel out of the analysis chamber, the at least partially discharged process fluid being analyzed.

48. (canceled)

49. The valve cage according to claim 1, wherein the analyzer comprises the sensor configured to detect the chemical and/or biological property of the process fluid.
